(19) United States
(12) Patent Application Publication
(10) Pub. No.: US 2022/0318759 A1
(43) Pub. Date: Oct. 6, 2022

(54) Method and System for Efficiently Scheduling Vehicle Test Drives

(71) Applicant: Honda Motor Co., Ltd., Tokyo (JP)

(72) Inventors: Christopher TARCHALA, Torrance, CA (US); Hanna GEE, Torrance, CA (US); Caitlyn Zhishang HAIN, Grand Rapids, MI (US)

(73) Assignee: Honda Motor Co., Ltd.

(21) Appl. No.: 17/217,045

(22) Filed: Mar. 30, 2021

(51) Int. Cl. G06Q 10/10; G06Q 10/06; G06Q 10/04; G06F 16/903

(52) U.S. Cl. CPC G06Q 10/1095; G06Q 10/06312; G06Q 10/047; G06F 16/903

(57) ABSTRACT

A method and system for efficiently scheduling vehicle test drives is disclosed. A user of an application can search for vehicles at nearby dealerships. Upon receiving the search results, the user can easily remove undesired vehicles from the list. After removing all undesired vehicles from the list, the user can request test drive scheduling for all the vehicles via a single interface. The system may then communicate with vendors to determine test drive appointment availability and present the user with only dates for which there are available appointments for all of the vehicles. The system may allow a user to select appointment times from a drop-down menu. The system may also generate an optimized schedule by considering the distances between vendors, estimated duration of each appointment, and a starting location for the user.

### BACKGROUND

The embodiments relate generally to methods and systems for improving test drive scheduling efficiency.

Vehicle test drives are an important part of the process of purchasing (or leasing) a new motor vehicle, such as a car, truck, or motorcycle. Test driving a vehicle allows a consumer to get a sense of the vehicle handling, comfort, and other aspects of the vehicle that are difficult to assess while the vehicle is parked in a lot. When a consumer is already at a dealership talking with a salesperson about a particular vehicle, taking a test drive is fairly straightforward. However, for consumers shopping for vehicles online, determining a time and location to test driving vehicles is a greater logistical challenge.

There is a need in the art for a system and method that addresses the shortcomings discussed above.

### SUMMARY

Embodiments provide methods and systems for improving the efficiency of a process of scheduling vehicle test drives.

In one aspect, a method of improving the efficiency of scheduling motor vehicle test drives using an application includes steps of receiving, at the application, user input from a user corresponding to search criteria for motor vehicles and performing, using a vehicle search engine, a query based on the user input. The method also includes a step of displaying, for the user, a list of motor vehicles returned by the query. The method also includes a step of receiving user input corresponding to a first user selected motor vehicle and a second user selected motor vehicle, where the first user selected motor vehicle is available at a first vendor and where the second user selected motor vehicle is available at a second vendor that is different from the first vendor. The method also includes a step of establishing communication with a first vendor scheduling system and establishing communication with a second vendor scheduling system. The method also includes steps of requesting available test drive appointments for the first user selected motor vehicle from the first vendor scheduling system and requesting available test drive appointments for the second user selected motor vehicle from the second vendor scheduling system. The method also includes a step of using a scheduling module to identify a first date when both the first vendor and the second vendor have available test drive appointments and a second date when both the first vendor and the second vendor have available test drive appointments. The method also includes steps of displaying the first date and the second date for the user, and receiving user input corresponding to a user selected date, where the user selected date includes the first date or the second date. The method also includes steps of automatically scheduling, via communication with the first vendor scheduling system, a first test drive appointment for the first user selected vehicle on the user selected date and automatically scheduling, via communication with the second vendor scheduling system, a second test drive appointment for the second user selected vehicle on the user selected date.

In another aspect, a method of optimizing a vehicle test drive schedule for a user of an application includes steps of receiving, at the application, a set of user selected vehicles, requesting available test drive appointments from a set of vendors, and receiving, from the user, a home location. The method also includes steps of retrieving a vendor location for each vendor in the set of vendors and calculating an optimized test drive schedule using at least the available test drive appointments, the home location, and the vendor locations. The method also includes a step of displaying, for the user, the optimized test drive schedule.

In another aspect, a system for improving the efficiency of scheduling motor vehicle test drives includes a processor and machine-readable media including instructions. The instructions, when executed by the processor, cause the processor to receive, at the application, user input from a user corresponding to search criteria for motor vehicles and perform, using a vehicle search engine, a query based on the user input. The instructions further cause the processor to display, for the user, a list of motor vehicles returned by the query and receive user input corresponding to a first user selected motor vehicle and a second user selected motor vehicle, where the first user selected motor vehicle is available at a first vendor and where the second user selected motor vehicle is available at a second vendor that is different from the first vendor. The instructions further cause the processor to establish communication with a first vendor scheduling system and establish communication with a second vendor scheduling system, request available test drive appointments for the first user selected motor vehicle from the first vendor scheduling system, and request available test drive appointments for the second user selected motor vehicle from the second vendor scheduling system. The instructions further cause the processor to use a scheduling module to identify a first date when both the first vendor and the second vendor have available test drive appointments and a second date when both the first vendor and the second vendor have available test drive appointments. The instructions further cause the processor to display the first date and the second date for the user and receive user input corresponding to a user selected date, where the user selected date includes the first date or the second date. The instructions further cause the processor to schedule, via communication with the first vendor scheduling system, a first test drive appointment for the first user selected vehicle on the user selected date and schedule, via communication with the second vendor scheduling system, a second test drive appointment for the second user selected vehicle on the user selected date.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments can be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is a schematic view of a mobile device running a test drive scheduling application, according to an embodiment;

FIG. 2 is a schematic view of a mobile device running an application displaying a list of vehicle entries;

FIG. 3 is a schematic view of a user interacting with an application, according to an embodiment;

FIG. 4 is a schematic view of an application responding to a user action, according to an embodiment;

FIG. 5 is a schematic view of a user interacting with an application, according to an environment;

FIG. 6 is a schematic view showing the relationship between multiple scheduling systems and a local calendar, according to an embodiment;

FIG. 7 is a schematic view of an application displaying a local calendar for a user, according to an embodiment;

FIG. 8 is a schematic view of an application providing an interface for selecting multiple test drive appointment times, according to an embodiment;

FIG. 9 is a schematic view of an application providing options for a user to input information, according to an embodiment;

FIG. 10 is a schematic view of a test drive scheduling software environment, according to an embodiment;

FIG. 11 is a schematic view of a method for automatically scheduling test drives, according to an embodiment;

FIG. 12 is a schematic view of inputs and outputs to a schedule optimization module, according to an embodiment; and

FIG. 13 is a schematic view of a method of updating a set of user dates for scheduling test drives, according to an embodiment.

### DETAILED DESCRIPTION

Embodiments provide methods and systems for improving test drive scheduling efficiency, including automatically scheduling test drives for multiple motor vehicles, even when the vehicles are located at different vendors (such as car dealerships).

Throughout this disclosure, references to components or modules generally refer to items that logically can be grouped together to perform a function or group of related functions. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

Throughout this application, an “interface” may be understood to refer to a mechanism for communicating content through a client application to an application user. In some examples, interfaces may include pop-up windows that may be presented to a user via native application user interfaces (UIs), controls, actuatable interfaces, interactive buttons or other objects that may be shown to a user through native application UIs, as well as mechanisms that are native to a particular application for presenting associated content with those native controls. In addition, the terms “actuation” or “actuation event” or “triggering event” refers to an event (or specific sequence of events) associated with a particular input or use of an application via an interface, which can trigger a change in the display of the application. Furthermore, a “native control” refers to a mechanism for communicating content through a client application to an application user. For example, native controls may include actuatable or selectable options or “buttons” that may be presented to a user via native application UIs, touch-screen access points, menus items, or other objects that may be shown to a user through native application UIs, segments of a larger interface, as well as mechanisms that are native to a particular application for presenting associated content with those native controls. The term “asset” refers to content that may be presented in association with a native control in a native application. As some non-limiting examples, an asset may include text in an actuatable pop-up window, audio associated with the interactive click of a button or other native application object, video associated with a teaching user interface, or other such information presentation.

Furthermore, graphical user interfaces (GUIs) can be used to present information to a user in the form of icons, graphics, or other types of interactive elements. Such interactive elements are generally associated with a particular action or command. A user typically has to supply an input to a computing system that is associated with the interactive elements presented on the graphical user interface to execute the particular action or command. As used herein, “interactive element” broadly includes a wide variety of graphical tools or components, such as graphical icons, graphical menus, graphical buttons, hyperlinks, images, and any other element which can be displayed on a graphical display and associated with or otherwise linked to an action or process that is to be performed upon activation of an interactive element.

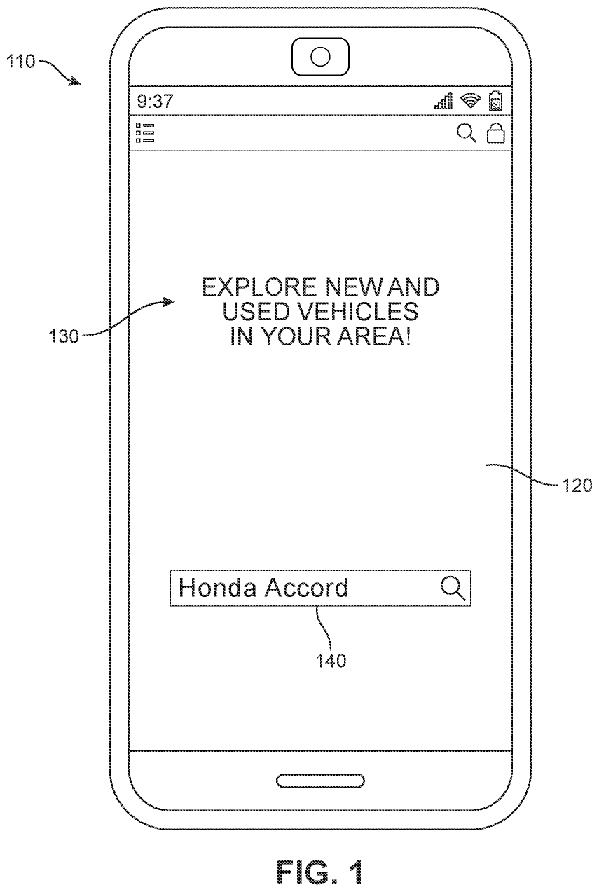

For purposes of introduction, FIG. 1 is a schematic view of a computing device 110 in the form of a smartphone. In other embodiments, computing device 110 could be a tablet, laptop, desktop, or another type of computing device. Computing device 110 includes a display 120 (in this case, a touchscreen display) that provides a viewing and interactive mechanism for the user. The display 120 presents a test drive scheduling application (“app”) 130, which allows a user to find and schedule (or “book”) test drives for multiple vehicles within the environment of a single application.

Once loaded, app 130 may prompt a user to enter search terms (or “key words”) for a new vehicle search. Specifically, app 130 may include a search box 140. In the exemplary embodiment, a user has input “Honda Accord” as a search term into search box 140. However, it may be appreciated that this is only one example of a search term. More generally, search terms can include any terms related to the make, model, class, trim, color, or any other relevant features a user may want to search when looking for a new or used vehicle.

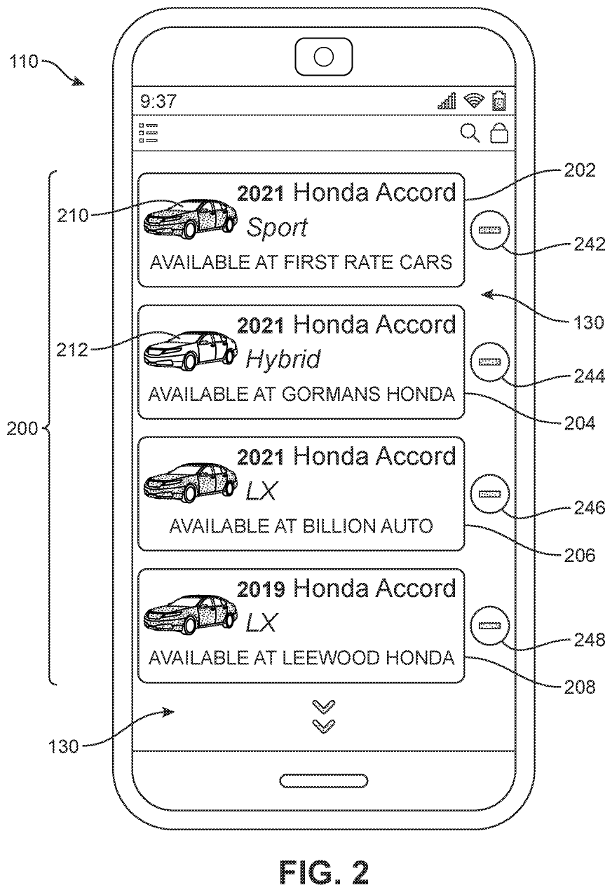

After entering desired search terms, the user may submit the query. In FIG. 2, which is another schematic view of computing device 110 shown running app 130, a set of search results may be returned. Specifically, a list of vehicle entries (“list”) 200 may be displayed for the user. This list may include multiple motor vehicle entries matching the user's search terms. Each motor vehicle entry provides information about a particular motor vehicle that may be available for sale or leasing at a vendor. For clarity, the embodiments describe vendors of cars as “car dealerships”. However, it may be appreciated that in other embodiments, any other vendors that offer vehicles for sale, leasing, or renting, may be included in the search results.

In the present embodiment, it is presumed that app 130 has access to user profile information, and/or a user's current location. Therefore, app 130 may return only results from nearby dealerships. In other embodiments, a user could specify a location along with (or as part of) the initial query. In still other embodiments, a user may have the option of selecting a maximum distance that they are willing to travel for a test drive. In such a case, app 130 may only return results for vehicles at dealerships within the maximum distance.

In the embodiment shown in FIG. 2, list 200 includes a first vehicle entry 202, a second vehicle entry 204, a third vehicle entry 206, and a fourth vehicle entry 208. Each vehicle entry represents a particular vehicle and provides information about the vehicle such as the year, make and model of the vehicle. For example, first vehicle entry 202 includes the information “2021 Honda Accord.” Each entry also includes the trim level of the vehicle. For example, first vehicle entry 202 includes the information “Sport,” to indicate the trim level. Additionally, each vehicle entry includes the dealership where the vehicle is being sold. For example, first vehicle entry 202 includes “First Rate Cars,” which is the name of the dealership where the vehicle is being sold. In addition, each vehicle entry may include an image of the vehicle. This image may display the color of the vehicle. For example, first vehicle entry 202 includes a vehicle image 210, which shows a grey Honda Accord. By contrast, second vehicle entry 204 includes a vehicle image 212, which shows a white Honda Accord.

It may be appreciated that the information shown for each vehicle entry is only intended to be an example of the kinds of information that could be displayed in an initial list for a user. Moreover, in some embodiments, when a user clicks on a particular vehicle entry the app may display additional details for the user.

As seen in FIG. 2, app 130 displays a selection tool for each vehicle entry. Specifically, first vehicle entry 202 is accompanied by a first selection tool 242, second vehicle entry 204 is accompanied by a second selection tool 244, third vehicle entry 206 is accompanied by a third selection tool 246, and fourth vehicle entry 208 is accompanied by a fourth selection tool 248.

In this example, each selection tool is an interactive UI element displaying a minus sign (“−”) to indicate that a user can remove the vehicle entry from the list by touching that accompanying UI element. Of course, it may be appreciated that in other embodiments, any other suitable interactive elements could be used to allow users to remove vehicle entries from the list. In one embodiment, for example, each vehicle entry comprises an interactive element and users could use a swiping gesture to remove vehicle entries from the list.

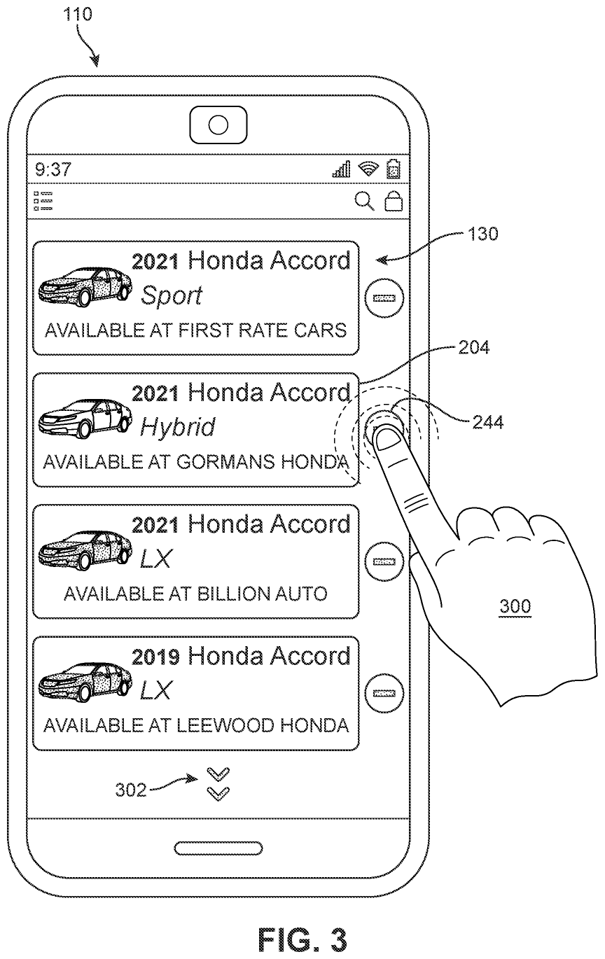

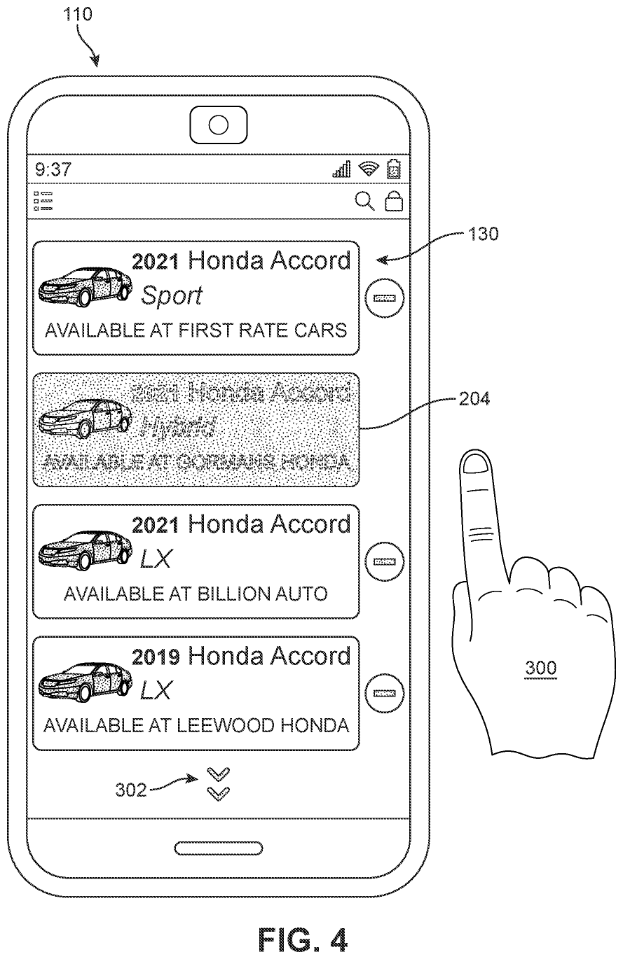

Providing a list of removable vehicle entries allows users to narrow the search results to a set of vehicles they are interested in test driving. As seen in FIGS. 3-4, a user 300 may touch second selection tool 244. This action provides a triggering event for removing second vehicle entry 204 from list 200. In some cases, the appearance of the selected vehicle entry could be changed to indicate it has been removed by the user, as shown in FIG. 4. This could allow users to reset the state of the vehicle entry at a later time if they decide they do want to test drive the vehicle after all. However, in other embodiments, a vehicle entry could simply disappear from the list after being selected.

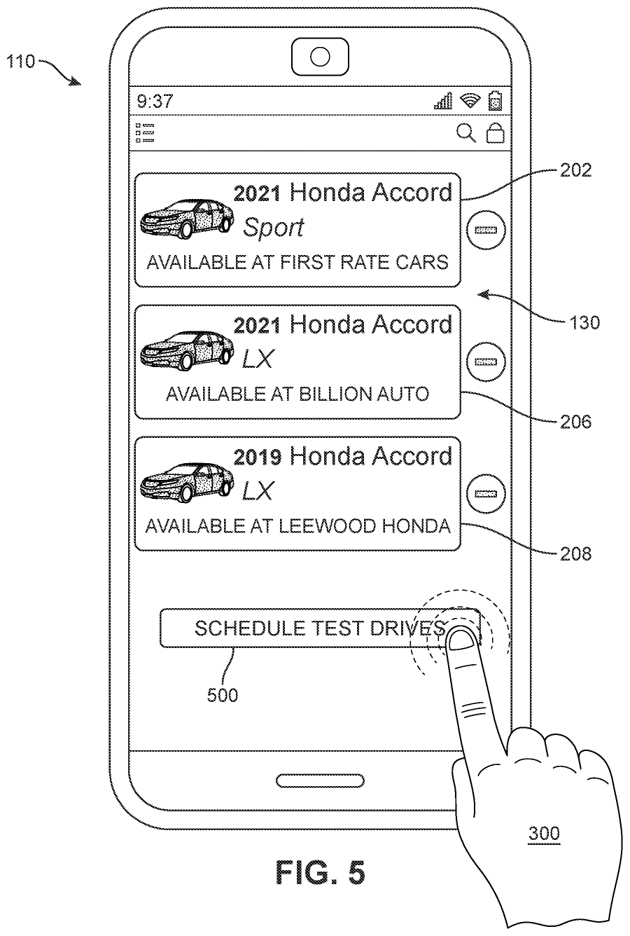

As shown in FIGS. 3-4, app 130 may display a “scroll down” icon 302 to indicate that further results are available to be viewed. Once the user has scrolled through all available entries in list 200, a user could indicate they are done and ready to schedule test drives for all the vehicles represented by active entries in the list. In the embodiment shown in FIG. 5, user 300 may press button 500, which is labeled “Schedule Test Drives,” to proceed with scheduling.

In the exemplary embodiment, user 300 is interested in test driving three different vehicles. Each vehicle is located at a different dealership. For example, a “2021 Honda Accord, Sport, Grey” (first vehicle entry 202) is available for a test drive at “First Rate Cars.” A “2021 Honda Accord, LX, Grey” (third vehicle entry 206) is available for a test drive at “Billion Auto.” A “2019 Honda Accord LX, Grey” is available at “Leewood Honda.”

Rather than have a user individually schedule a test drive at each of these three different dealerships, the embodiments provide a method for automatically identifying dates where test drives are available at all three dealerships, and then automatically scheduling the test drives.

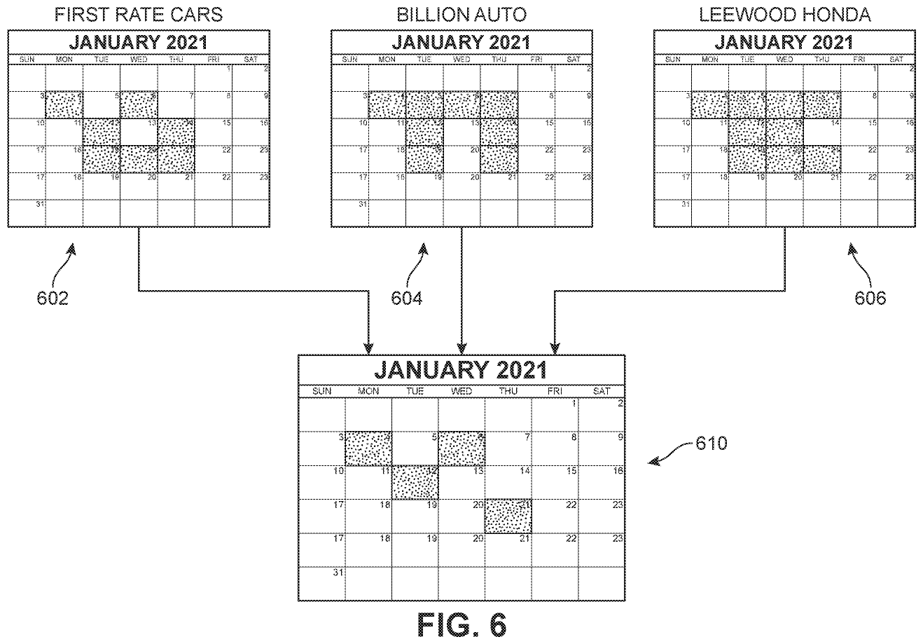

For purposes of understanding the automated scheduling process, FIG. 6 shows an exemplary process of retrieving appointment availability for three different dealerships and syncing them to a single merged calendar that shows only dates for which all three dealerships have available test drive appointments. Referring to FIG. 6, the present system can retrieve scheduling information, including the availability of test drive appointments in a given time frame, from multiple dealerships. In this case, the system can retrieve first scheduling information 602 from “First Rate Cars,” second scheduling information 604 from “Billion Auto,” and third scheduling information 606 from “Leewood Honda.” The scheduling information from each of these dealerships, which includes all available test drive appointments in a particular time frame (such as a month), can then be analyzed and merged to populate a local calendar 610 that can be presented to a user.

As shown in FIG. 6, each of the three dealerships have slightly different availability for test drives during the month of January. Because the exemplary system is only interested in days where a user could test drive all three vehicles, the system populates local calendar 610 only with these days. Thus, in FIG. 6 local calendar 610 displays four available days (indicated with shading) for scheduling all three test drives, even though each of the individual dealers may have availability on additional days. This configuration simplifies the scheduling process and reduces the time spent driving back and forth to each dealership over the course of multiple days.

For purposes of illustration, scheduling information for each dealership scheduling system is shown schematically as a calendar. However, it may be appreciated that the scheduling data could be stored in any manner within the representative scheduling systems. Moreover, the data passed from any dealership scheduling system to the local system (local calendar 610) could comprise any format.

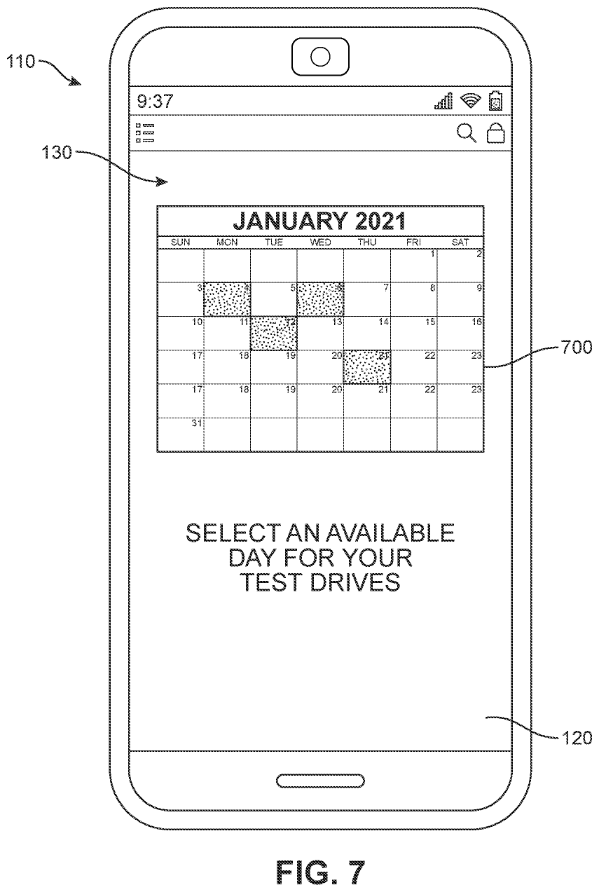

As shown in FIG. 7, a calendar element 700 can be displayed for a user, which may include the available dates for which a user is able to test drive all the selected vehicles. In some cases, calendar element 700 may be an interactive element. A user may then select one or more dates from the calendar that are received as inputs to the system.

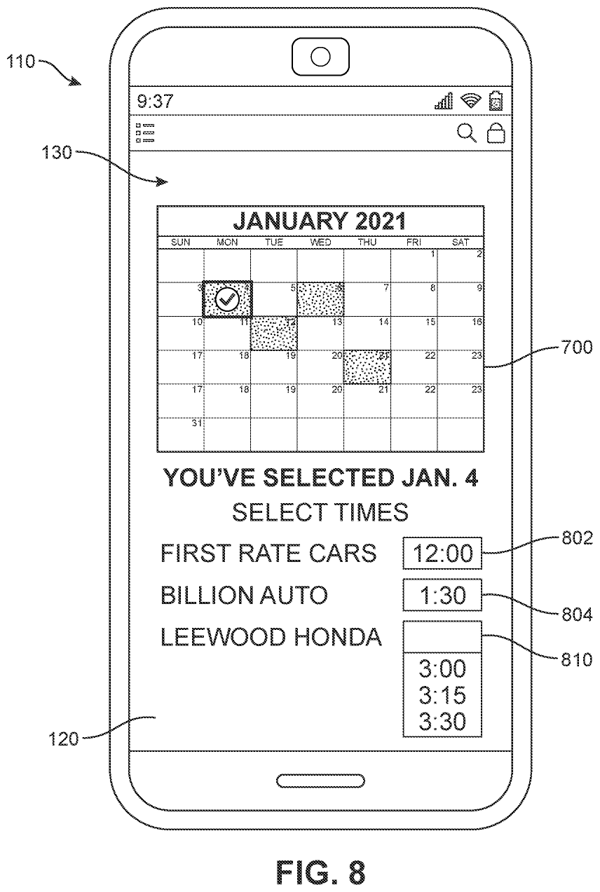

Once a user selects a particular date, app 130 may then provide a list of available time slots for each dealership, as in FIG. 8. For example, in the embodiment shown in FIG. 8, a user has already selected a first timeslot 802 (“12:00”) for a test drive at First Rate Cars and a second timeslot 804 (“1:30”) for a test drive at Billion Auto. Additionally, app 130 has provided a drop-down menu 810 for the user to select an available test drive timeslot at Leewood Honda.

Once a user has selected their preferred appointment times for test driving each selected vehicle, app 130 may initiate a scheduling process that sends booking requests to the scheduling systems of the three dealerships.

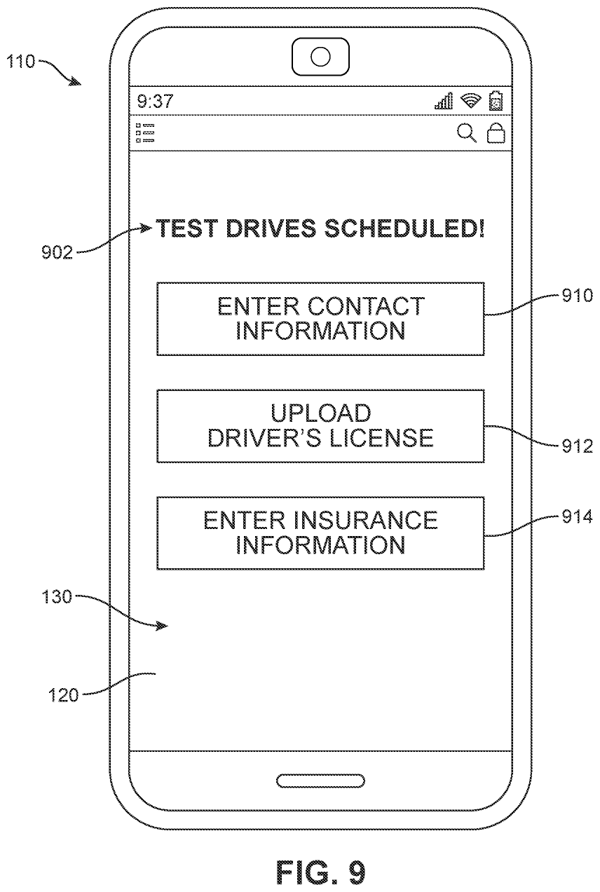

FIG. 9 is a schematic view of an optional step in the exemplary process. In some cases, app 130 could display a confirmation message to a user confirming that the appointments have been made with the dealership. In this case, app 130 displays a confirmation message 902 (“Test Drives Scheduled!”) at the top of the screen.

Once the test drives have been scheduled, app 130 may also provide a way for users to fill out and/or upload information ahead of their test drive appointments. These include a first selection 910 for entering the user's contact information, a second selection 912 for uploading a picture of a driver's license, and a third selection 914 for entering vehicle insurance information. These options allow a user to complete any paperwork necessary for the test drive before they arrive at the dealership, further improving the efficiency of the test drive experience.

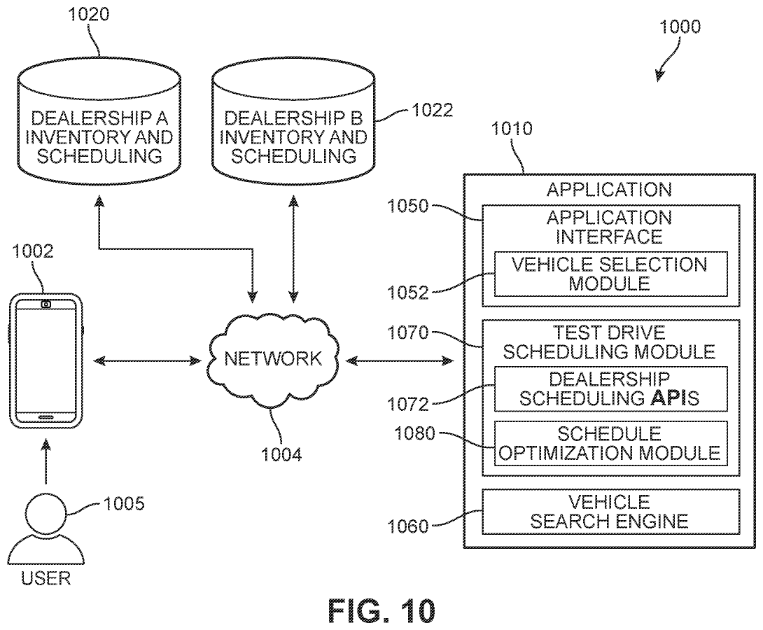

In order to provide the reader with a greater appreciation of the embodiments, FIG. 10 depicts a schematic overview of an embodiment of a test drive scheduling application environment (“environment”) 1000. FIG. 10 is shown for the purposes of illustrating one or more exemplary embodiments and not for purposes of limiting the same. The components of the environment 1000, including application system (“app” or “application”) 1010, as well as the components of other systems, hardware architectures, and software architectures discussed herein, may be combined, omitted, or organized into different architectures for various embodiments.

In FIG. 10, the environment 1000 includes a computing device 1002 that communicates over a network 1004 to application 1010. For purposes of illustration, a user 1005 accesses the front-end user interface of the application provided by the application 1010 via computing device 1002. The computing device 1002 may include provisions for communicating with the application 1010. In some embodiments, the communication may occur over network 1004. Generally, network 1004 may be any type of network, including, but not limited to Wi-Fi networks, cell phone networks, as well as any other type of network. Furthermore, network 1004 may be associated with any type of network standard including, but not limited to CDMA, TDMA, GSM, AMPS, PCS, analog and/or W-CDMA.

Components of the application environment may be in communication with backend systems for one or more dealerships. For example, as shown in FIG. 10, components of the environment can communicate with inventory and scheduling systems 1020 of a first dealership (“Dealership A”) as well as inventory and scheduling systems 1022 of a second dealership (“Dealership B”). For purposes of clarity FIG. 10 shows just two inventory and scheduling systems, however it may be appreciated that in other embodiments application 1010 could communicate with any number of inventory and scheduling systems.

In some embodiments, application 1010 may be hosted on a cloud-based server that may include a plurality of interconnected servers (not shown), including but not limited to web servers, data servers, database servers, domain controllers, backup servers, and the like. The host device or devices may include suitable processors and memory for running application 1010.

The application 1010 may further include a plurality of modules that provide a plurality of functions. In different embodiments, application 1010 includes an application interface module 1050 which is configured to present graphical elements for application 1010. Application interface module 1050 may further include vehicle selection module 1052 which is configured to display search results returned by user queries. Vehicle selection module 1052 may also provide interactive features that allow a user to select or remove particular vehicles from the displayed results.

Application 1010 may also include a test drive scheduling module (“scheduling module”) 1070. Scheduling module 1070 is configured to interface with dealerships scheduling systems (such as scheduling systems 1020 and scheduling systems 1022). In some cases, communication can be facilitated using dealerships scheduling APIs 1072 which allow application 1010 to retrieve available appointment times and submit scheduling requests on behalf of a user.

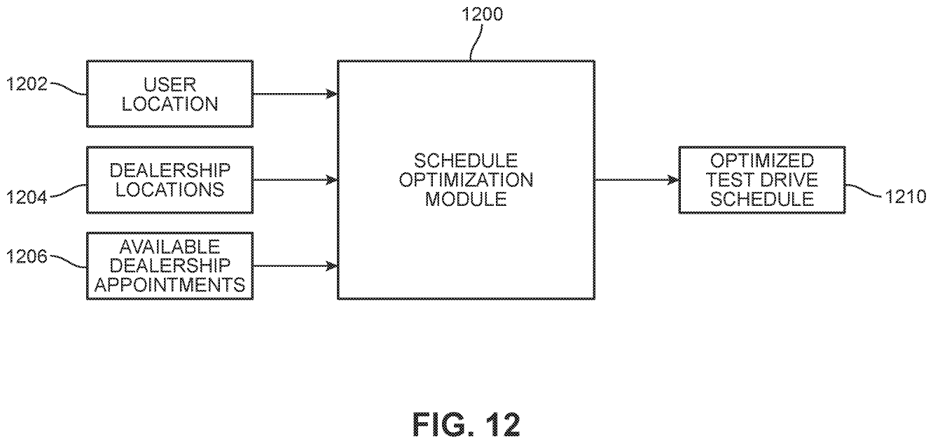

In some embodiments, application 1010 may also include a schedule optimization module 1080 which is configured to automatically generate an optimized test drive schedule for a user according to various constraints. The operation of optimization module 1080 is described in further detail below and shown, for example, in FIG. 12.

Application 1010 may also include a vehicle search engine 1060 which is configured to return a list of vehicle entries in response to user queries. In some cases, vehicle search engine 1060 may search through dealership inventory systems. In other cases, vehicle search engine 1060 could search a composite database that lists available vehicles from all dealerships in a particular geographic area. In still other embodiments, vehicle search engine 1060 could be an external component to application 1010 that is queried using a suitable API.

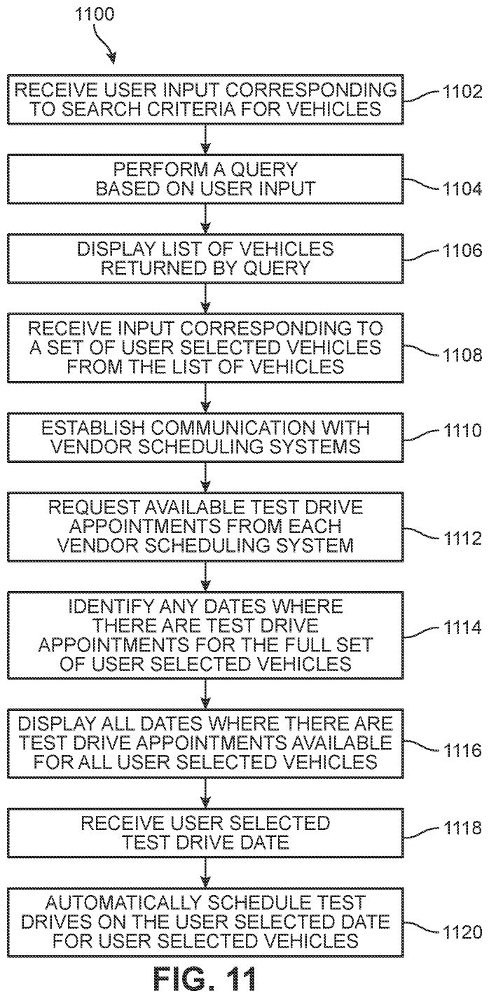

FIG. 11 is a flow chart illustrating an embodiment of a method 1100 for improving the efficiency of scheduling motor vehicle test drives using an application. In a first step 1102, an application may receive user input corresponding to search criteria for vehicles. In step 1104, the application may perform a query based on the user input. The query results can be displayed for the user as a list of vehicles in step 1106.

In step 1108, the system receives input corresponding to a set of user selected vehicles from the list of vehicles displayed in step 1106. In some cases, the set of selected vehicles may be determined by allowing the user to remove vehicles they do not want to test drive from the list, as shown in FIGS. 3-4.

In step 1110, the application may establish communication with the different vendor's scheduling systems. In step 1112 the application may request available test drive appointments from each vendor scheduling system (as shown, for example, in FIG. 6).

In step 1114, the application may identify any dates where there are test drive appointments available for the full set of user selected vehicles. In situations where there is at least a first user selected vehicle at a first vendor and at least a second user selected vehicle at a second vendor, the system may identify any dates where there are test drive appointments at both the first vendor and the second vendor.

Once the system has determined all the dates for which a user could test drive all the vehicles, the application may display these dates for the user in step 1116. The user may then select one of the displayed dates, which is received as user selected test drive date in step 1118.

In step 1120, after a user has selected a test drive date, the application can automatically schedule, on behalf of the user, test drive appointments for each of the user selected vehicles on the same user selected date.

In some embodiments, once a user has selected a test drive date, the system could display a set of different available appointment times at each dealership, as shown in FIG. 8. Alternatively, in other embodiments, the application could automatically determine appointment times for the user. In some embodiments, the application could determine an optimized schedule of test drive appointments for the user without requiring the user to select particular appointment times, and in response to receiving a user selected date.

FIG. 12 is a schematic view of various inputs and outputs for a test drive schedule optimization module (“optimization module”) 1200. As shown in FIG. 12, the inputs may include a user location 1202, dealership locations 1204, and available dealership appointments 1206. User location 1202 may refer to a user's home, or else, any other location where the user may start from on the scheduled test drive date. In some cases, the user location could be one of the dealerships where the user plans to start.

Using these inputs, optimization module 1200 may determine an “optimized schedule” that minimizes total time, total driving distance, or any other suitable optimization criteria. Each optimized schedule, therefore, may comprise an ordered set of dealership specific appointment times. For example, in the exemplary embodiment shown in FIGS. 1-9, an optimized schedule could be given as: “12:20 pm at Billion Auto; 1:30 pm at First Rate Cars; 2:30 at Leewood Honda.” This schedule may be determined to ensure the shortest round trip for a user that includes each of the dealerships, considers available appointment times, and also accounts for estimated test drive durations and estimated travel time between dealerships. As shown in FIG. 12, the output of optimization module 1200 is an optimized test drive schedule 1210.

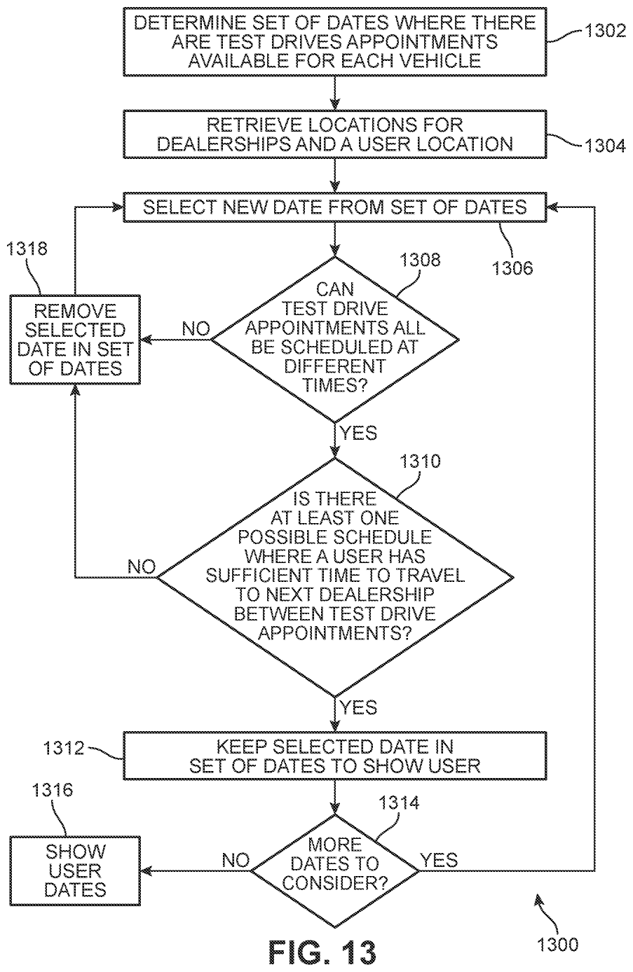

FIG. 13 is a schematic view of a detailed method 1300 for determining which dates are suitable for test driving all vehicles in the set of user selected vehicles. Starting in step 1302, the application may determine the set of dates where there are test drives appointments available for each vehicle. However, just because there is an appointment available for every vehicle on a particular day does not mean it is feasible for a user to make all three appointments. For example, if any two appointments at different dealerships are for the same time, it will be impossible for the user to test drive the two corresponding vehicles. Likewise, if two appointment times are sufficiently close together, or the dealerships are sufficiently far apart, it still may not be feasible for the user to travel from one dealership to the other and make the second appointment time. To mitigate for these possibilities, method 1300 includes additional steps to ensure that only those dates where it is feasible for the user to test drive all the user selected vehicles are displayed as options for scheduling test drives.

In step 1304, the application retrieves the locations for the relevant dealerships and a user location. In step 1306, the application selects a new date from the set of dates determined in step 1302.

In step 1308, the application ensures the necessary test drive appointments can be scheduled at different times. If so, the application proceeds to step 1310. In step 1310, the application determines if there is at least one possible schedule, given all the possible appointment times, where the user has sufficient time to travel to the next dealership between test drive appointments. If so, the application proceeds to step 1312 where the application keeps the selected date in the set of dates that will be displayed for the user. In step 1314, if there are additional dates in the set of dates determined in step 1302 that should be considered, the step returns to step 1306 to select another date and check for possible scheduling issues in subsequent steps. Otherwise, if the application has already considered all the dates in the set of dates from step 1302, the application can proceed to displaying the (possibly revised) set of dates for the user in step 1316.

If the application determines that either there is no way to schedule all the test drive appointments at different times (step 1308) or there is no schedule that gives the user sufficient travel time between appointments (step 1310), the application may proceed to step 1318. In step 1318, the selected date is removed from the set of dates since there's no practical way to schedule all the test drives on that date.

It may be appreciated that in some cases, the application may not find any suitable dates where test drives are available for all the user selected vehicles. In such cases, the application could prompt a user to expand the range of acceptable dates (for example, asking the user if dates further in the future could work). In another embodiment, the application could prompt the user to remove at least one vehicle from the set of user selected vehicles in order to ensure its possible to schedule all the test drives on the same day.

It may be appreciated that in other embodiments, an application could schedule test drives across two or more days. For example, in some cases the application could schedule automatically schedule test drives for a set of selected vehicles over the course of two days, three days, a week, or any other period that is suitable for a user.

The following includes definitions of selected terms employed herein. The definitions include various examples and/or forms of components that fall within the scope of a term and that can be used for implementation. The examples are not intended to be limiting. Aspects of the present disclosure can be implemented using hardware, software, or a combination thereof and can be implemented in one or more computer systems or other processing systems. In one example variation, aspects described herein can be directed toward one or more computer systems capable of carrying out the functionality described herein. An example of such a computer system includes one or more processors. A “processor”, as used herein, generally processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

The apparatus and methods described herein and illustrated in the accompanying drawings by various blocks, modules, components, circuits, steps, processes, algorithms, etc. (collectively referred to as “elements”) can be implemented using electronic hardware, computer software, or any combination thereof. Whether such elements are implemented as hardware or software depends upon the particular application and design constraints imposed on the overall system. By way of example, an element, or any portion of an element, or any combination of elements can be implemented with a “processing system” that includes one or more processors. One or more processors in the processing system can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described can be implemented in hardware, software, firmware, or any combination thereof. If implemented in software, the functions can be stored on or encoded as one or more instructions or code on a computer-readable medium. Computer-readable media includes computer storage media. Storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The processor can be connected to a communication infrastructure (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system can include a display interface that forwards graphics, text, and other data from the communication infrastructure (or from a frame buffer) for display on a display unit. Display unit can include display, in one example. Computer system also includes a main memory, e.g., random access memory (RAM), and can also include a secondary memory. The secondary memory can include, e.g., a hard disk drive and/or a removable storage drive, representing a floppy disk drive, a magnetic tape drive, an optical disk drive, etc. The removable storage drive reads from and/or writes to a removable storage unit in a well-known manner. Removable storage unit, represents a floppy disk, magnetic tape, optical disk, etc., which is read by and written to removable storage drive. As will be appreciated, the removable storage unit includes a computer usable storage medium having stored therein computer software and/or data.

Computer system can also include a communications interface. Communications interface allows software and data to be transferred between computer system and external devices. Examples of communications interface can include a modem, a network interface (such as an Ethernet card), a communications port, a Personal Computer Memory Card International Association (PCMCIA) slot and card, etc. Software and data transferred via communications interface are in the form of signals, which can be electronic, electromagnetic, optical or other signals capable of being received by communications interface. These signals are provided to communications interface via a communications path (e.g., channel). This path carries signals and can be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals. These computer program products provide software to the computer system. Aspects described herein can be directed to such computer program products. Communications device can include communications interface.

Computer programs (also referred to as computer control logic) are stored in main memory and/or secondary memory. Computer programs can also be received via communications interface. Such computer programs, when executed, enable the computer system to perform various features in accordance with aspects described herein. In particular, the computer programs, when executed, enable the processor to perform such features. Accordingly, such computer programs represent controllers of the computer system.

In variations where aspects described herein are implemented using software, the software can be stored in a computer program product and loaded into computer system using removable storage drive, hard disk drive, or communications interface. The control logic (software), when executed by the processor, causes the processor to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The foregoing disclosure of the preferred embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the present embodiments.

1. A method, comprising the steps of:
receiving, at a graphical user interface (GUI) of a mobile application running on a computing device, user input from a user corresponding to search criteria for motor vehicles;
performing, using a vehicle search engine, a query based on the user input;
displaying within the GUI, for the user, a list of vehicle elements returned from the query, wherein each vehicle element in the list of vehicle elements represents a motor vehicle and a vendor where the user can test drive the motor vehicle, and wherein at least two different vendors are represented in the list of motor vehicle elements;
displaying, within the GUI, an interactive scheduling element that triggers a test drive scheduling module;
receiving a user selection corresponding to the interactive scheduling element and, in response, triggering the test drive scheduling module to automatically schedule test drive appointments for every motor vehicle represented in the displayed list of vehicle elements, by:
establishing communication with scheduling systems for each different vendor represented in the list of vehicle elements;
requesting and receiving a set of available test drive appointments for each motor vehicle represented in the displayed list of vehicle elements;
retrieving vendor locations for every vendor represented in the displayed list of vehicle elements;
determining a set of dates to display for the user, such that for each date in the set of dates there is at least one test drive schedule, comprising an ordered list of test drive appointments and vendors where the test drive appointments are held, such that:
the at least one test drive schedule includes a test drive appointment for every motor vehicle represented in the list of vehicle elements; and
the at least one test drive schedule provides sufficient time for the user to travel between subsequent test drive appointments at different vendors based on the retrieved vendor locations;
displaying the set of dates for the user;
receiving user input corresponding to a user selected date, the user selected date comprising a date from the set of dates; and
automatically scheduling test drive appointments for every motor vehicle represented in the list of vehicle elements, on the user selected date.

2. The method according to claim 1, wherein establishing communication with the scheduling systems for each different vendor includes using one or more application programming interfaces.

3. The method according to claim 1, wherein automatically scheduling the test drive appointments includes using an optimization module to determine an optimized test drive schedule for the user selected date.

4. The method according to claim 1, wherein displaying the set of dates includes displaying a calendar for the user, wherein the set of dates are highlighted on the calendar.

5. The method according to claim 1, wherein the method further includes receiving a user selection corresponding to one of the listed vehicle elements and, in response, removing the selected vehicle element from the displayed list of vehicle elements.

6. The method according to claim 5, wherein the method further includes displaying a selector element adjacent at least one vehicle element in the list of vehicle elements, wherein the selector element can be used to remove the at least one vehicle element from the list of vehicle elements.

7. The method according to claim 1, wherein the method further includes ensuring that no two test drive appointments in the test drive schedule occur at the same time.

8. The method according to claim 7, wherein the method further includes determining if a user has sufficient time to complete a first test drive at a first vendor that is scheduled at a first test drive appointment time and travel to a second vendor in time to for a second test drive at a second test drive appointment time.

9. The method according to claim 3, wherein the optimized test drive schedule is optimal with respect to total driving time.

10. A method, comprising the steps of:
receiving, at a graphical user interface (GUI) of a mobile application running on a computing device, a set of user selected vehicles, wherein each user selected vehicle in the set of user selected vehicles is associated with a corresponding vendor from a set of vendors;
requesting, using one or more application programming interfaces, available test drive appointments from a set of vendor scheduling systems corresponding to the set of vendors;
retrieving a vendor location for each vendor in the set of vendors;
calculating an optimized test drive schedule that includes an ordered list of test drive appointments, wherein each test drive appointment in the list includes a test drive appointment time and an associated vendor, and wherein:
the optimized test drive schedule includes a test drive appointment for every vehicle in the set of user selected vehicles;
each test drive appointment in the optimized test drive schedule occurs on the same date; and
wherein calculating the optimized test drive schedule includes considering estimated travel times between at least two of the vendors in the set of vendors;
displaying, for the user within the GUI, the optimized test drive schedule; and
automatically scheduling, using the one or more application programming interfaces, test drive appointments at each vendor in the set of vendors according to the optimized test drive schedule.

11. The method according to claim 10, wherein calculating the optimized test drive schedule further includes:
estimating a travel time between every pair of vendors in the set of vendors; and
estimating a test drive appointment duration for each vehicle in the set of user selected vehicles.

12. The method according to claim 10, wherein the optimized test drive schedule minimizes total time required to complete the test drive schedule compared to other potential test drive schedules.

13. The method according to claim 10, wherein the optimized test drive schedule minimizes total miles driven to complete the test drive schedule compared to other potential test drive schedules.

14. A system comprising a processor and machine-readable media including instructions which, when executed by the processor, cause the processor to:
receive, at a graphical user interface (GUI) of a mobile application running on a computing device, user input from a user corresponding to search criteria for motor vehicles;
perform, using a vehicle search engine, a query based on the user input;
display within the GUI, for the user, a list of vehicle elements returned from the query, wherein each vehicle element in the list of vehicle elements represents a motor vehicle and a vendor where the user can test drive the motor vehicle, and wherein at least two different vendors are represented in the list of motor vehicle elements;
display, within the GUI, an interactive scheduling element that triggers a test drive scheduling module;
receive a user selection corresponding to the interactive scheduling element and, in response, trigger the test drive scheduling module to automatically schedule test drive appointments for every motor vehicle represented in the displayed list of vehicle elements, by:
establishing communication with scheduling systems for each different vendor represented in the list of vehicle elements;
requesting and receiving a set of available test drive appointments for each motor vehicle represented in the displayed list of vehicle elements;
retrieving vendor locations for every vendor represented in the displayed list of vehicle elements;
determining a set of dates to display for the user, such that for each date in the set of dates there is at least one test drive schedule, comprising an ordered list of test drive appointments and vendors where the test drive appointments are held, such that:
the at least one test drive schedule includes a test drive appointment for every motor vehicle represented in the list of vehicle elements; and
the at least one test drive schedule provides sufficient time for the user to travel between subsequent test drive appointments at different vendors based on the retrieved vendor locations;
displaying the set of dates for the user;
receiving user input corresponding to a user selected date, the user selected date comprising a date from the set of dates; and
automatically scheduling test drive appointments for every motor vehicle represented in the list of vehicle elements, on the user selected date.

15. The system according to claim 14, wherein the instructions further cause the processor to display the set of dates in a calendar form.

16. The system according to claim 14, wherein the instructions further cause the processor to establish communication using with the vendor scheduling systems using an application programming interface.

17. The system according to claim 14, wherein the instructions further cause the processor to calculate an optimized test drive schedule for the user selected date.

18. The system according to claim 17, wherein the optimized test drive schedule is optimal with respect to total driving time between different motor vehicle vendors.

19. The system according to claim 17, wherein the optimized test drive schedule is optimal with respect to total driving distance between different motor vehicle vendors.

20. The system according to claim 14, wherein the instructions further cause the processor to display a selector adjacent at least one vehicle element, wherein the selector can be used to remove the at least one vehicle element from the list of vehicle elements.
